(19) United States
(12) Patent Application Publication
(10) Pub. No.: US 2006/0139160 A1
(43) Pub. Date: Jun. 29, 2006

(54) Fire detection system for a building

(76) Inventors: Tung-Chu Lin, Chung-Ho City (TW); Chuan-Ming Wu, Chung-Ho City (TW)

Correspondence Address: BRUCE H. TROXELL, SUITE 1404, 5205 LEESBURG PIKE, FALLS CHURCH, VA, 22041, US

(21) Appl. No.: 11/011,201

(22) Filed: Dec. 15, 2004

(51) Int. Cl. G08B 29/00; G08B 1/00; G08B 17/10; G08B 19/00

(52) U.S. Cl. 340/506; 340/628; 340/531; 340/521

(57) ABSTRACT

Provided is an intelligent AV type fire detection system for a large or high-rise building comprising smoke detectors, a controller, activated by any one smoke detector detecting a fire, alarms activated by the controller, image fetching devices wherein one image fetching device nearest the scene of fire is activated by the controller for generating an AV signal, and a communication module. The controller is adapted to generate an AV fire signal contained images from the scene of fire, and the communication module is adapted to receive the AV fire signal from the controller and transfer the AV fire signal to recipients including a fire department and a police department via a telephone company. The recipients thus can directly confirm whether a fire breaks out in a very short time, resulting in a saving of precious time for extinguishing fire.

### BACKGROUND OF THE INVENTION

1. Field of the Invention

The present invention relates to fire detection devices and more particularly to an intelligent audio-video (AV) type fire detection system for a high-rise office building or apartment house with characteristics including true alarm, automatic notification, etc.

2. Description of Related Art

Smoke detectors are well known. A conventional alarm system installed in a high-rise office building or apartment house is shown in FIG. 1. As shown, the system comprises a plurality of smoke detectors distributed throughout every floor of the building, the smoke detector being adapted to detect smoke, gas (e.g., carbon monoxide), or the like, a plurality of sub-controllers each installed in a single floor, the sub-controller including a manual alarm, and a controller for receiving an alarm signal from the smoke detector in the event that a fire is detected. Alternatively, a person may activate the manual alarm for generating an alarm signal and sending the same to the controller when he/she sees a fire. The system further comprises a plurality of audible alarms installed throughout every floor or each installed in the sub-controller, and a plurality of beacons installed throughout every floor or each installed in the sub-controller. Each of the alarms and beacons is activated by the controller in response to receiving the alarm signal by the controller. Moreover, the controller may perform a predetermined alarm sequence to automatically dial an emergency telephone number 911 to a local fire or police department. Alternatively, a shift person at the management office of the building may dial the emergency telephone number 911 to a local fire or police department.

It is often that a shift person at emergency center who receives the call may make a call to the management office for confirmation in which the shift person may request the management office to send a person to the scene for confirmation since there is possibility of false alarms. Once confirmed, fire fighters and fire engines will go to the scene of fire immediately. However, the confirmation may takes more than ten minutes. As such, precious time for distinguishing fire may be wasted, resulting in large casualties. In addition, prior alarm systems are only able to issue alarm and are not unable to take image of the scene where a fire breaks out. Thus, this can cause trouble to fire analysts since the scene may be completely destroyed by the fire (i.e., increase difficulties of fire analysis).

The above drawbacks have not been successfully solved by any patent documents as far as the present inventor is aware. Thus, a need exists for a better method of detecting fire, notifying the same, and more.

### SUMMARY OF THE INVENTION

It is an object of the present invention to provide a fire detection system mounted in a large building comprising a plurality of smoke detectors distributed throughout the building for detecting fire; a controller activated by one of the smoke detectors sending a fire signal thereto; a plurality of alarms distributed throughout the building, the alarms being activated by the controller; a plurality of image fetching devices distributed throughout the building, one of the image fetching devices nearest the scene of fire being activated by the controller for generating an AV signal; and communication means, wherein the controller is adapted to generate an AV fire signal contained images from the scene of fire, and the communication means is adapted to receive the AV fire signal from the controller and transfer the AV fire signal to a plurality of predetermined recipients including a fire department and a police department via a telephone company. By utilizing this AV type intelligent fire detection system, the recipients are able to directly confirm whether a fire breaks out or not in a very short time, resulting in a saving of precious time for extinguishing fire.

It is another object of the present invention to provide a fire detection system mounted in a large building comprising a plurality of smoke detectors distributed throughout the building for detecting fire; a controller activated by one of the smoke detectors sending a fire signal thereto; a plurality of alarms distributed throughout the building, the alarms being activated by the controller; a plurality of image fetching devices distributed throughout the building, one of the image fetching devices nearest the scene of fire being activated by the controller for generating an AV signal; communication means; and a system monitor center, wherein the controller is adapted to generate an AV fire signal contained images from the scene of fire, the communication means is adapted to receive the AV fire signal from the controller and transfer the AV fire signal to the system monitor center via a telephone company, and system monitor center is adapted to process the AV fire signal and send the processed AV fire signal to a plurality of predetermined recipients including a fire department and a police department via a telephone company. In one aspect of the present invention, the controller comprises a receiver assembly and a digital AV transmitter assembly electrically coupled thereto. In another aspect of the present invention, there is further provided a bridge interconnected the AV transmitter assembly and the image fetching devices, and the AV transmitter assembly comprises a receiver for receiving an alarm signal from the receiver assembly; a CPU for processing the alarm signal, generating an enable signal, sending the enable signal to one of the image fetching devices nearest the scene of fire via the bridge, receiving the AV signal from the image fetching device, and combining the AV signal with the prerecorded alarm message to generate an AV fire signal; a television camera for fetching images of the fire taken by the image fetching device via the bridge; an image processing unit for converting the images into image signals with increased resolution and sending the image signals to the CPU for combination; and a communication unit coupled to an output of the CPU for sending the AV fire signal to the communication module for notification.

In a further aspect of the present invention, either the communication module is comprised of a typical telephone line, a cable network, a wireless network, and a dedicated line or the communication module is a typical telephone line, a cable network, a wireless network, or a dedicated line.

The above and other objects, features and advantages of the present invention will become apparent from the following detailed description taken with the accompanying drawings.

### BRIEF DESCRIPTION OF THE DRAWINGS

FIG. 1 is a block diagram of a conventional fire alarm system installed in a high-rise building;

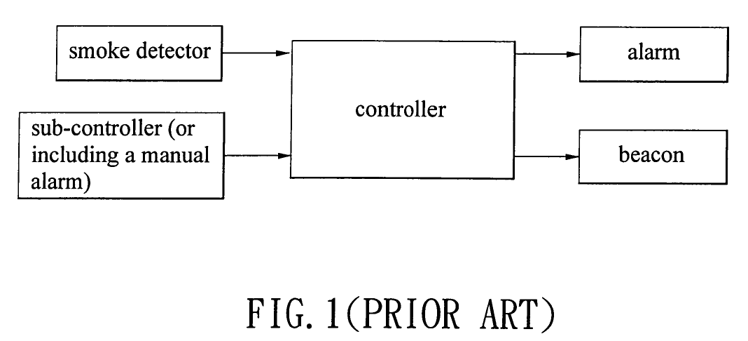

FIG. 2 is a block diagram of a first preferred embodiment of fire detection system for a high-rise building according to the invention;

FIG. 3 is a detailed block diagram of the controller and other associated components shown in FIG. 2;

FIG. 4 is a detailed block diagram and flow chart of the CPU and other associated components shown in FIG. 3;

FIG. 5 is a detailed block diagram and flow chart of the bridge and other associated components shown in FIG. 3;

FIG. 6 is a first flow chart of the first preferred embodiment in response to a fire breaking out;

FIG. 7 is a second flow chart of the first preferred embodiment in response to a fire breaking out;

FIG. 8 is a block diagram of a second preferred embodiment of fire detection system for a high-rise building according to the invention; and

FIG. 9 is a detailed block diagram and flow chart of the system monitor center and other associated components shown in FIG. 8.

### DETAILED DESCRIPTION OF THE PREFERRED EMBODIMENTS

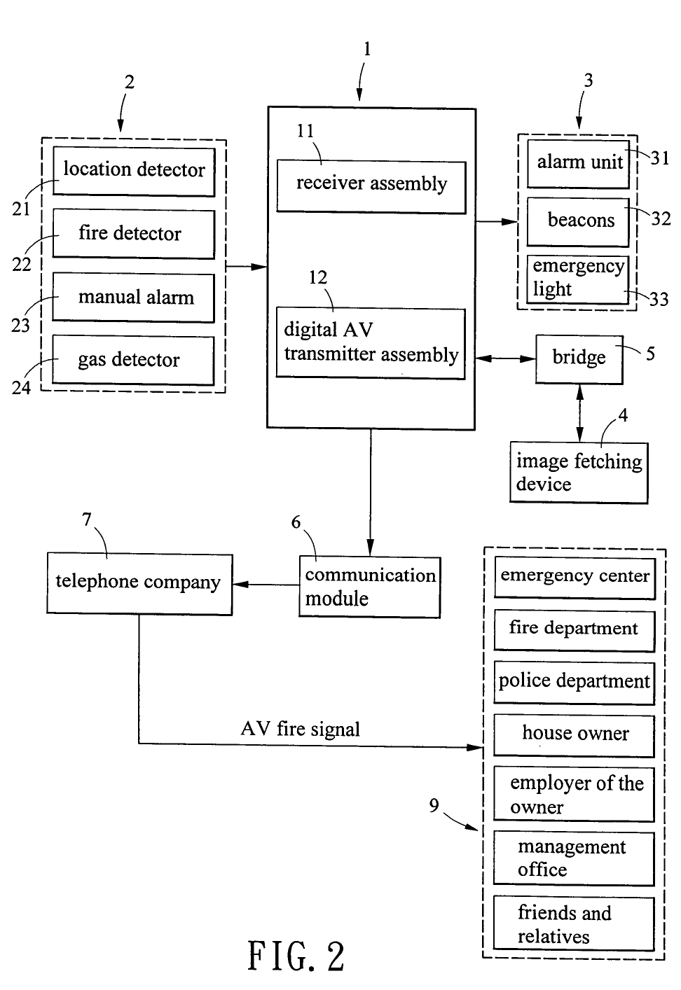

Referring to FIGS. 2 to 7, there is shown a fire detection system installed in a high-rise building (e.g., office building or apartment house) or a large building (e.g., shopping center) in accordance with a first preferred embodiment of the invention. The system comprises a controller 1; a plurality of smoke detectors 2 and alarms 3 distributed throughout every floor of the building; a plurality of image fetching devices 4 distributed throughout every floor of the building; a bridge 5; and a communication module 6. Each component will be described in detailed below.

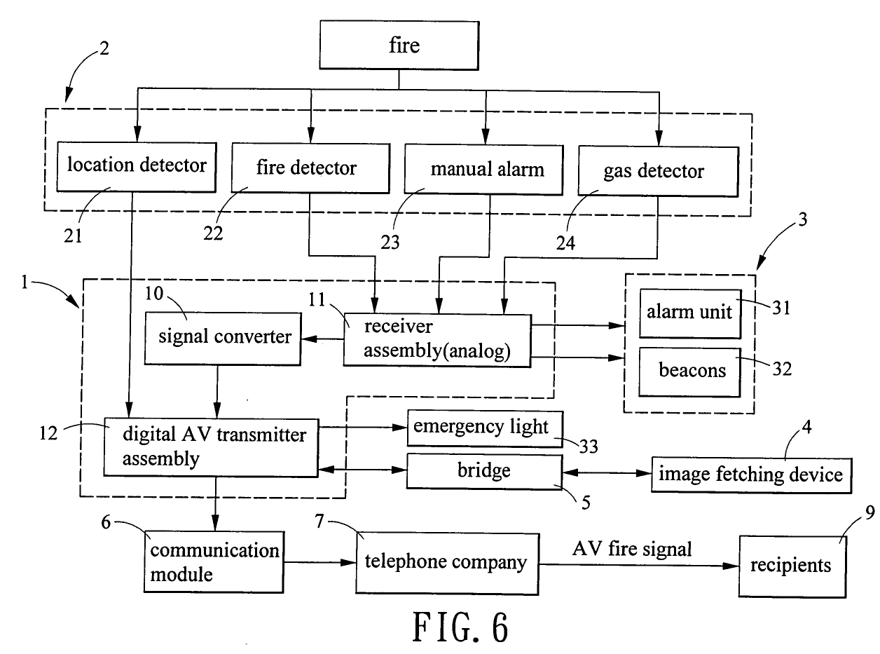

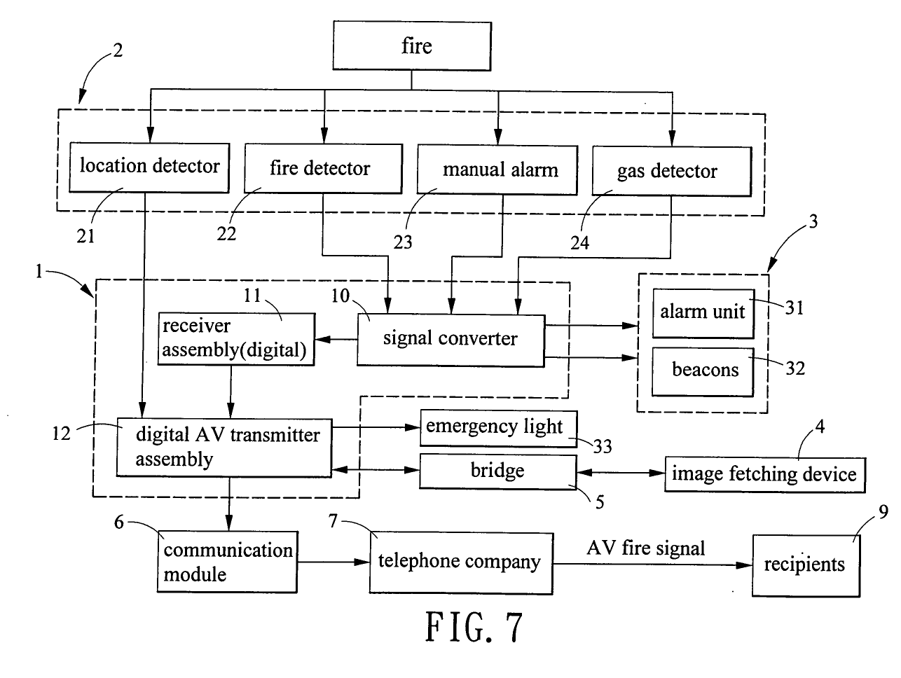

As shown in FIG. 2, the controller 1 comprises a receiver assembly 11 and a digital AV transmitter assembly 12 electrically coupled thereto. The receiver assembly 11 is a well known device and is electrically coupled to reach of the smoke detectors 2 and alarms 3 for receiving alarm signal therefrom. The receiver assembly 11 is implemented as a digital or analog one (see FIGS. 6 and 7).

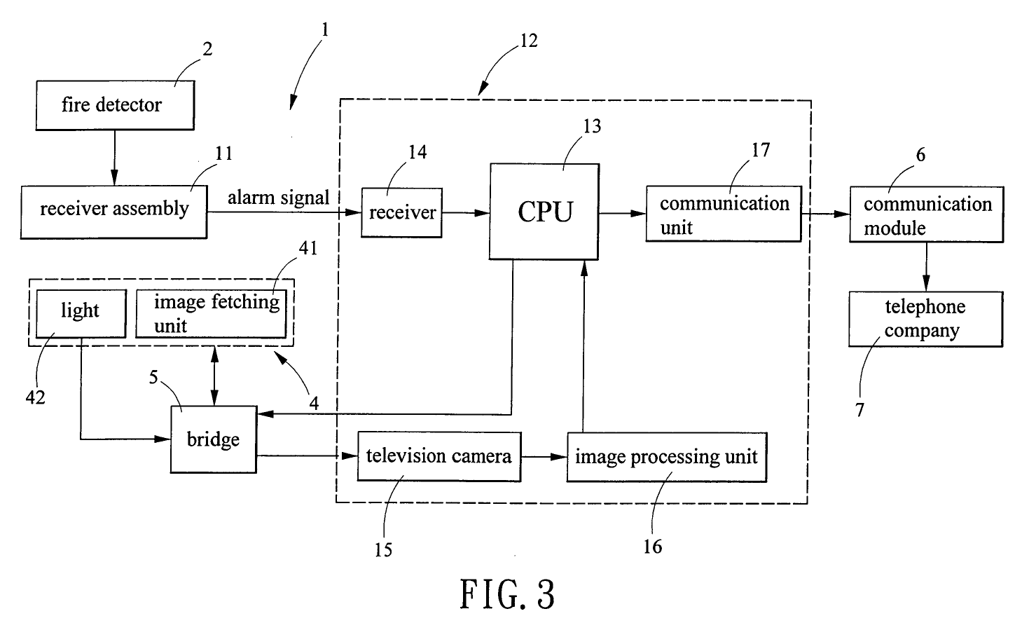

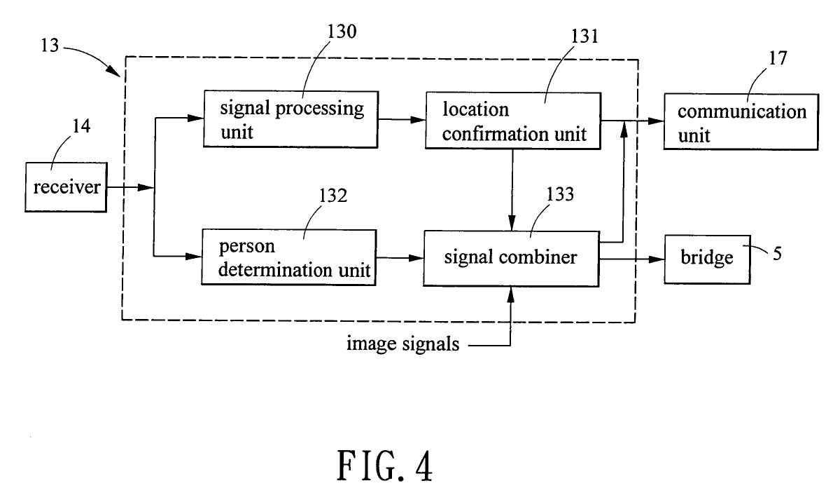

As shown in FIGS. 3 and 4, the transmitter assembly 12 comprises a central processing unit (CPU) 13, a receiver 14, a television camera 15, an image processing unit 16, and a communication unit 17. The smoke detector 2 is adapted to detect smoke, gas (e.g., carbon monoxide), or the like. Upon detection of a fire by the smoke detector 2, the smoke detector 2 generates an alarm signal and transfers the same to the receiver assembly 11. Next, the receiver 14 is activated by the CPU 13 to receive the alarm signal from the receiver assembly 11. In response to receiving the alarm signal from the receiver 14 by the CPU 13, the signal is then sent to a signal processing unit 130 and a person determination unit 132 respectively. Next, the processed signal is sent to a location confirmation unit 131 for confirming location of the fire (e.g., room of some floor). At the same time, the signal is analyzed by the person determination unit 132 for determining persons living in or near the scene of fire. The location confirmation signal is then sent to a signal combiner 133. Also, the person determination signal is sent from the person determination unit 132 to the signal combiner 133. The location confirmation signal is then sent to the bridge 5 through the signal combiner 133 so as to activate an image fetching device 4 nearest the scene of fire. Also, the television camera 15 is enabled to fetch images of the fire taken by the image fetching device 4 via the bridge 5. The images are then converted into image signals by the image processing unit 16 with increased resolution. Image signals are then combined with the location confirmation signal and the person determination signal at the signal combiner 133 so as to generate AV fire signal contained images from the scene of fire. The AV fire signal in turn is sent to the communication unit 17. Eventually, the communication unit 17 sends AV fire signal to the communication module 6 for notification.

The smoke detectors 2 are comprised of location detectors 21, fire detectors 22, manual alarms 23, and gas detectors 24 distributed throughout numerous locations of the building for adequate protection of occupants. All of the above components are well known and are commercially available. Thus, a detailed description of their installations and wiring is omitted herein for the sake of brevity.

The alarms 3 are comprised of alarm units 31, beacons 32, and emergency lights 33 distributed throughout numerous locations of the building for adequate protection of occupants. All of the above components are well known and are commercially available. Thus, a detailed description of their installations and wiring is omitted herein for the sake of brevity.

The image fetching devices 4 are located at the same places as the smoke detectors 2 and alarms 3. In the first preferred embodiment of the invention (see FIG. 3), the image fetching device 4 comprises an image fetching unit (e.g., conventional camera, digital camera, aperture camera, or the like) 41, and a light 42 for illuminating an area focused by the image fetching unit 41. The light 42 is a piece of independent lighting equipment. Alternatively, the emergency light 33 can be used as light. Thus, the light 42 in some location which has a sufficient light, or a light built-in type image fetching unit, can be omitted.

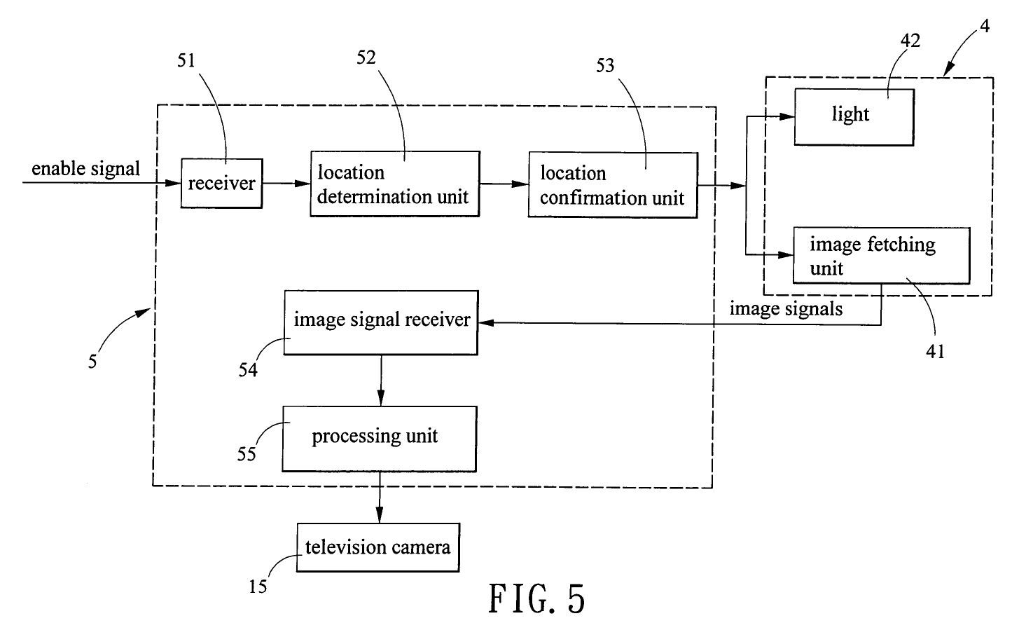

Referring to FIG. 5, the bridge 5 comprises a receiver 51 coupled to output of CPU 13 for receiving enable signal therefrom, a location determination unit 52 for determining location of fire, a location confirmation unit 53 for confirming the determination prior to activating the image fetching device 4 nearest the scene of fire, an image signal receiver 54 coupled to the image fetching unit 41 for receiving image signals, and a processing unit 55 for processing the image signals and generating a signal prior to sending the signal to the television camera 15.

Referring to FIG. 2, the communication module 6 is adapted to communicate fire notification from the controller 1 to a telephone company 7. The communication module 6 is implemented as a typical telephone line, a cable network, a wireless network, a dedicated line, a first combination of all of the above, or a second combination of some of the above.

Referring to FIG. 2 in conjunction with FIGS. 6 and 7, the structure and flow chart of the first preferred embodiment of the invention will be described in detailed below. Note that the controller 1 as shown in FIG. 6 is an analog one and the controller 1 as shown in FIG. 7 is a digital one. The differences therebetween are that at an output terminal of the analog receiver assembly 11 there is provided a signal converter 10 for converting an analog signal into a digital one which in turn is sent to the digital AV transmitter assembly 12. There is a prerecorded alarm message stored in the transmitter assembly 12.

In the event that a fire breaks out, the smoke detector 2 including location detector 21, fire detector 22, and manual alarm 23 nearest the scene of fire will detect it immediately. And in turn, an alarm signal is sent to the receiver assembly 11. The receiver assembly 11 then sends a digital alarm signal to the transmitter assembly 12. Note that the alarm signal is required to convert into a digital one by the signal converter 10 if the receiver assembly 11 is an analog one as discussed above. Moreover, the receiver assembly 11 transfers notification to the alarms 3 for activating alarm units 31, beacons 32, and emergency lights 33. The alarm signal is processed by the transmitter assembly 12 for confirming location of the fire. Thereafter, the bridge 5 is activated by the transmitter assembly 12 for activating the image fetching device 4 nearest the scene of fire. The activated image fetching device 4 is adapted to fetch images at the scene of fire and send the images to the transmitter assembly 12 via the bridge 5. The images are combined with image signals and a prerecorded alarm message to generate an AV fire signal contained images from the scene of fire at the transmitter assembly 12. The transmitter assembly 12 then sends the AV fire signal (i.e., notification) to predetermined recipients 9 including emergency center (i.e., telephone number 911), local fire department, local police department, owner of the house at or nearest the scene of fire, employer of the owner, management office, and friends and relatives of the owner) via the communication module 6 and the telephone company 7.

The AV fire signal (i.e., notification) is comprised of images from the scene of fire and a prerecorded alarm message such that the recipients are able to directly confirm whether a fire breaks out or not in a very short time. As a result, more precious time is saved for extinguishing the fire. Moreover, police department is able to quickly apprehend person(s) who purposely set the fire by viewing recorded images contained in the AV fire signal if it is arson.

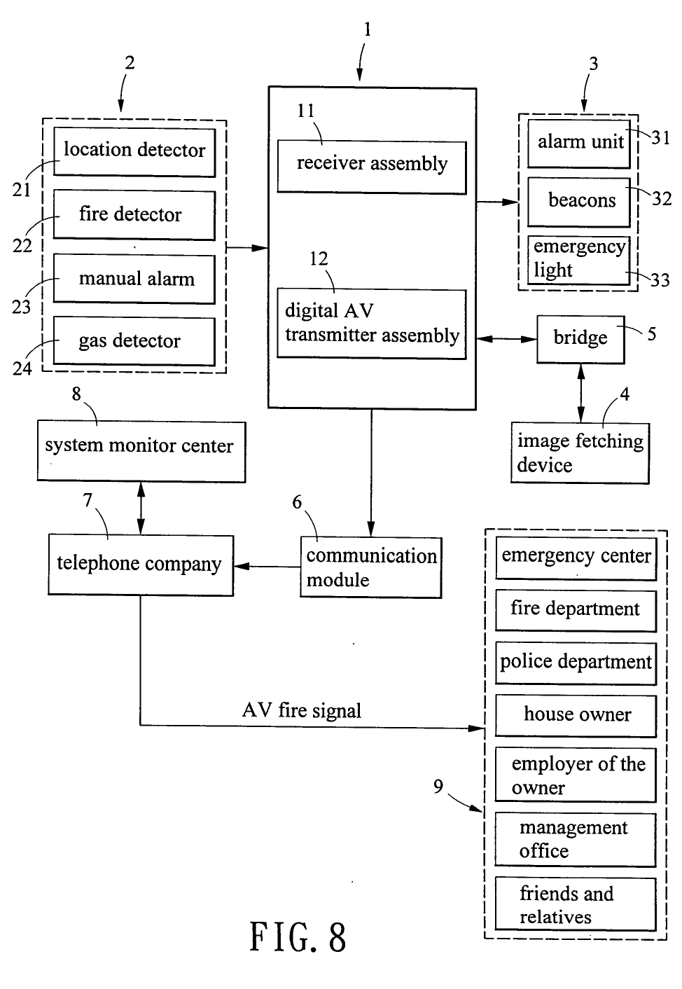

Referring to FIG. 8, there is shown a second preferred embodiment of the invention. The second preferred embodiment substantially has same structure as the first preferred embodiment. The differences between the first and the second preferred embodiments, i.e., the characteristics of the second preferred embodiment are detailed below. An additional system monitor center 8 is provided. The system monitor center 8 is adapted to receive AV fire signal from the communication module 6 via the telephone company 7 for processing. The processed AV fire signal (i.e., notification) is then sent to predetermined recipients 9 via the telephone company 7.

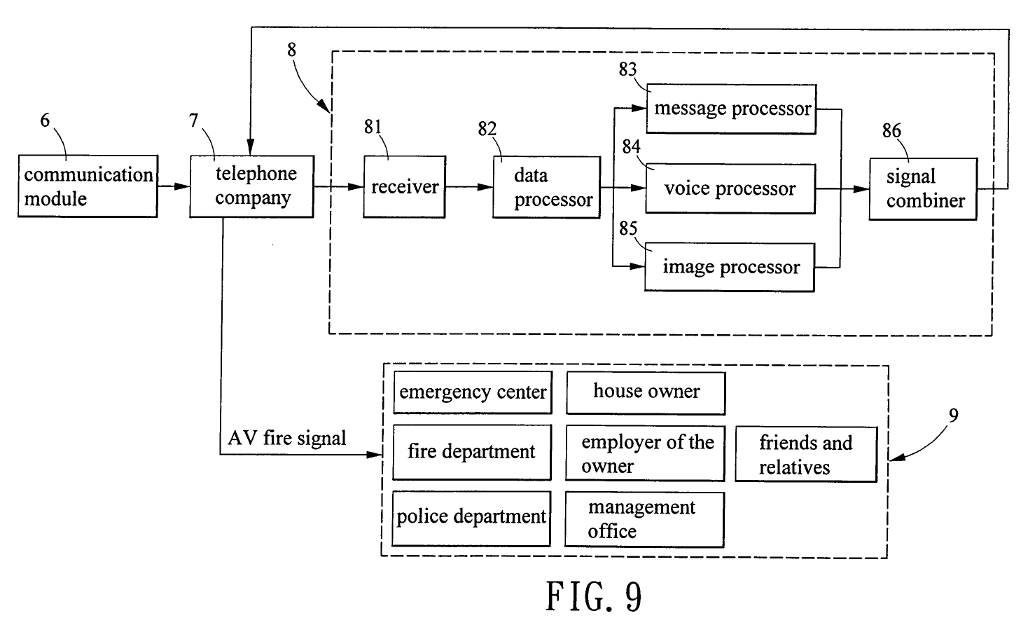

Referring to FIG. 9, the system monitor center 8 is comprised of a receiver 81 for receiving image signals from the image fetching device 4 via the communication module 6 and the telephone company 7, a data processor 82 for processing the image signals, a message processor 83 for fetching messages contained in the signals processed by the data processor 82, a voice processor 84 for fetching voice contained in the signals processed by the data processor 82, an image processor 85 for fetching images contained in the signals processed by the data processor 82, and a signal combiner 86 for combining above messages, voice, and images as an AV fire signal. The AV fire signal is then sent to the telephone company 7 as notification which is then transferred to predetermined recipients 9.

The receiver 81 is implemented as a computer by the invention. It is contemplated that the computer may be replaced by any other devices having signal receiving capability in other embodiments.

While the invention herein disclosed has been described by means of specific embodiments, numerous modifications and variations could be made thereto by those skilled in the art without departing from the scope and spirit of the invention set forth in the claims.

What is claimed is:

1. A fire detection system for a building comprising:
a plurality of smoke detectors distributed throughout the building for detecting fire;
a controller activated by one of the smoke detectors sending a fire signal thereto;
a plurality of alarms distributed throughout the building, the alarms being activated by the controller;
a plurality of image fetching devices distributed throughout the building, one of the image fetching devices nearest the scene of fire being activated by the controller for generating an AV signal; and
communication means,
wherein the controller is adapted to generate an AV fire signal contained images from the scene of fire, and the communication means is adapted to receive the AV fire signal from the controller and transfer the AV fire signal to a plurality of predetermined recipients including a fire department and a police department via a telephone company.

2. The system of claim 1, wherein the AV fire signal is comprised of the AV signal and a prerecorded alarm message.

3. The system of claim 1, wherein the controller comprises a receiver assembly and a digital AV transmitter assembly electrically coupled thereto.

4. The system of claim 3, wherein the receiver assembly is a digital or an analog one.

5. The system of claim 4, further comprising a signal converter electrically interconnected the receiver assembly and the AV transmitter assembly for converting an analog signal into a digital one and sending the digital signal to the AV transmitter assembly.

6. The system of claim 3, further comprising a bridge interconnected the AV transmitter assembly and the image fetching devices, and wherein the AV transmitter assembly comprises:
a receiver for receiving an alarm signal from the receiver assembly;
a CPU for processing the alarm signal, generating an enable signal, sending the enable signal to one of the image fetching devices nearest the scene of fire via the bridge, receiving the AV signal from the image fetching device, and combining the AV signal with the prerecorded alarm message to generate an AV fire signal;
a television camera for fetching images of the fire taken by the image fetching device via the bridge;
an image processing unit for converting the images into image signals with increased resolution and sending the image signals to the CPU for combination; and
a communication unit coupled to an output of the CPU for sending the AV fire signal to the communication means for notification.

7. The system of claim 6, wherein the CPU comprises: a signal processing unit, a person determination unit, a location confirmation unit, and a signal combiner, and wherein the alarm signal is processed by the signal processing unit and the location confirmation unit sequentially for confirming location of the fire, concurrently the alarm signal is analyzed by the person determination unit for determining persons living in or near the scene of fire prior to sending to the signal combiner, the alarm signal with confirmed location of fire is sent to the bridge for activating one of the image fetching devices nearest the scene of fire, the image signals are sent back from the nearest image fetching device to the signal combiner for combining with the alarm signal with determined persons for generating an AV fire signal, and the communication unit is adapted to send the AV fire signal to the communication module for notification.

8. The system of claim 1, wherein the smoke detectors are comprised of location detectors, fire detectors, manual alarms, and gas detectors distributed throughout the building.

9. The system of claim 1, wherein the alarms are comprised of alarm units, beacons, and emergency lights distributed throughout the building.

10. The system of claim 1, wherein the image fetching device comprises an image fetching unit and a light.

11. The system of claim 10, wherein the image fetching unit is a television camera, a digital camera, or an aperture camera.

12. The system of claim 10, wherein the light is a piece of independent lighting equipment for illuminating an area focused by the image fetching unit.

13. The system of claim 10, wherein the light is an emergency light for illuminating an area focused by the image fetching unit.

14. The system of claim 1, wherein the bridge comprises a receiver for receiving the enable signal with determined and confirmed location from the AV transmitter assembly, a location determination unit for determining location of fire, a location confirmation unit for confirmation the determination prior to activating one of the image fetching devices nearest the scene of fire; an image signal receiver coupled to the image fetching device for receiving the image signals, and a processing unit for processing the image signals and generating a signal prior to sending the signal to the television camera of the AV transmitter assembly.

15. The system of claim 1, wherein the communication means is comprised of a typical telephone line, a cable network, a wireless network, and a dedicated line.

16. The system of claim 1, wherein the communication means is a typical telephone line, a cable network, a wireless network, or a dedicated line.

17. The system of claim 1, wherein the AV fire signal is comprised of images from the scene of fire and a prerecorded alarm message.

18. A fire detection system mounted in a large building comprising:
a plurality of smoke detectors distributed throughout the building for detecting fire;
a controller activated by one of the smoke detectors sending a fire signal thereto;
a plurality of alarms distributed throughout the building, the alarms being activated by the controller;
a plurality of image fetching devices distributed throughout the building, one of the image fetching devices nearest the scene of fire being activated by the controller for generating an AV signal;
communication means; and
a system monitor center,
wherein the controller is adapted to generate an AV fire signal contained images from the scene of fire, the communication means is adapted to receive the AV fire signal from the controller and transfer the AV fire signal to the system monitor center via a telephone company, and system monitor center is adapted to process the AV fire signal and send the processed AV fire signal to a plurality of predetermined recipients including a fire department and a police department via a telephone company.

19. The system of claim 18, wherein the AV fire signal is comprised of the AV signal and a prerecorded alarm message.

20. The system of claim 18, wherein the AV fire signal is comprised of images from the scene of fire and a prerecorded alarm message.

21. The system of claim 18, wherein the controller comprises a receiver assembly and a digital AV transmitter assembly electrically coupled thereto.

22. The system of claim 21, wherein the receiver assembly is a digital or an analog one.

23. The system of claim 22, further comprising a signal converter electrically interconnected the receiver assembly and the AV transmitter assembly for converting an analog signal into a digital one and sending the digital signal to the AV transmitter assembly.

24. The system of claim 21, further comprising a bridge interconnected the AV transmitter assembly and the image fetching devices, and wherein the AV transmitter assembly comprises:
a receiver for receiving an alarm signal from the receiver assembly;
a CPU for processing the alarm signal, generating an enable signal, sending the enable signal to one of the image fetching devices nearest the scene of fire via the bridge, receiving the AV signal from the image fetching device, and combining the AV signal with the prerecorded alarm message to generate an AV fire signal;
a television camera for fetching images of the fire taken by the image fetching device via the bridge;
an image processing unit for converting the images into image signals with increased resolution and sending the image signals to the CPU for combination; and
a communication unit coupled to an output of the CPU for sending the AV fire signal to the communication means for notification.

25. The system of claim 24, wherein the CPU comprises: a signal processing unit, a person determination unit, a location confirmation unit, and a signal combiner, and wherein the alarm signal is processed by the signal processing unit and the location confirmation unit sequentially for confirming location of the fire, concurrently the alarm signal is analyzed by the person determination unit for determining persons living in or near the scene of fire prior to sending to the signal combiner, the alarm signal with confirmed location of fire is sent to the bridge for activating one of the image fetching devices nearest the scene of fire, the image signals are sent back from the nearest image fetching device to the signal combiner for combining with the alarm signal with determined persons for generating an AV fire signal, and the communication unit is adapted to send the AV fire signal to the communication module for notification.

26. The system of claim 18, wherein the smoke detectors are comprised of location detectors, fire detectors, manual alarms, and gas detectors distributed throughout the building.

27. The system of claim 18, wherein the alarms are comprised of alarm units, beacons, and emergency lights distributed throughout the building.

28. The system of claim 18, wherein the image fetching device comprises an image fetching unit and a light.

29. The system of claim 28, wherein the image fetching unit is a television camera, a digital camera, or an aperture camera.

30. The system of claim 28, wherein the light is a piece of independent lighting equipment for illuminating an area focused by the image fetching unit.

31. The system of claim 28, wherein the light is an emergency light for illuminating an area focused by the image fetching unit.

32. The system of claim 18, wherein the bridge comprises a receiver for receiving the enable signal with determined and confirmed location from the AV transmitter assembly, a location determination unit for determining location of fire, a location confirmation unit for confirmation the determination prior to activating one of the image fetching devices nearest the scene of fire; an image signal receiver coupled to the image fetching device for receiving the image signals, and a processing unit for processing the image signals and generating a signal prior to sending the signal to the television camera of the AV transmitter assembly.

33. The system of claim 18, wherein the communication means is comprised of a typical telephone line, a cable network, a wireless network, and a dedicated line.

34. The system of claim 18, wherein the communication means is a typical telephone line, a cable network, a wireless network, or a dedicated line.

35. The system of claim 18, wherein the system monitor center:
a receiver for receiving the image signals from the image fetching device via the communication module and the telephone company;
a data processor for processing the image signals;
a message processor for fetching messages contained in the image signals processed by the data processor;
a voice processor for fetching voice contained in the image signals processed by the data processor;
an image processor for fetching images contained in the image signals processed by the data processor; and
a signal combiner for combining the fetched messages, voice, and images as an AV fire signal and sending the AV fire signal to the telephone company for notification.

36. The system of claim 35, wherein the receiver of the system monitor center is a computer.

37. The system of claim 35, wherein the receiver of the system monitor center is a device having signal receiving capability.
